(19) United States
(12) Patent Application Publication
(10) Pub. No.: US 2009/0073463 A1
(43) Pub. Date: Mar. 19, 2009

(54) IMAGE PROCESSING APPARATUS, IMAGE PROCESSING METHOD, AND COMPUTER-READABLE RECORDING MEDIUM

(75) Inventor: Akitoshi Yamada, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/212,496

(22) Filed: Sep. 17, 2008

(30) Foreign Application Priority Data
Sep. 19, 2007 (JP) 2007-242909

(51) Int. Cl. G06K 15/02

(52) U.S. Cl. 358/1.2

(57) ABSTRACT

An image processing apparatus that processes an input image to generate an output image to be recorded on a recording medium includes a first obtaining unit configured to obtain a size of the input image, a second obtaining unit configured to obtain a size of the recording medium, a setting unit configured to set, in two directions orthogonal to each other, an overrunning amount caused if the input image were recorded on the recording medium without a margin, a calculating unit configured to calculate a scaling factor in each of the two directions using the size of the recording medium, the overrunning amount, and the size of the input image, and a generating unit configured to perform a scaling operation on the input image in the two directions based on the respective scaling factors to generate an output image.

### BACKGROUND OF THE INVENTION

1. Field of the Invention

The present invention relates to an image processing technique for varying the size of an input image to generate an output image to be recorded on a recording sheet.

2. Description of the Related Art

Image scanning apparatuses are manufactured as single-function peripherals (image scanners) for computers. On the other hand, image scanning apparatuses are widely utilized in facsimile machines, copiers, and multifunction peripherals (MFPs). The MFPs have a plurality of functions for scanning, copying, and printing images and sending faxes.

Many image scanning apparatuses scan images utilizing relative movement between a scan head and a document. Based on a difference in a document conveying method, scanning methods employed in the image scanning apparatuses can be categorized into a method for moving a scan head to scan a document placed on a platen and a method for moving a document without moving the scan head.

Furthermore, based on a difference in a document feeding method, the scanning methods can be categorized into a manual method and a method for feeding a document to a scan position (it does not matter whether to move the document or the scan head) using an auto document feeder (ADF).

In addition, existing image scanning apparatuses employ two or more scanning methods instead of a single scanning method. For example, image scanning apparatuses capable of utilizing both of an ADF scanning method and a flatbed scanning method have emerged.

MFPs including such an image scanning apparatus not only utilize a scanned document image by recording the image on a recording sheet and sending a fax of the document image but also perform various kinds of processing in a process between scanning of a document and utilization of a document image. Furthermore, the MFPs can execute different kinds of processing on the document image according to the processing result.

For example, there are the following kinds of copy operations only regarding copy functions executed according to the processing result:
1) a normal copy operation for simply copying a document;
2) a (manual) repeated copy operation for repeatedly copying a document on recording sheets as many times as specified by an operator;
3) an (automatic) repeated copy operation for repeatedly copying a document as many times as the image of document can be recorded on recording sheets;
4) a mirror image copy operation for copying a mirror image of a document while inversing an image of the document;
5) an auto scaling copy operation for automatically determining a scaling factor to copy a document on a whole recording sheet; and
6) a marginless copy operation for copying a document on a whole recording sheet without providing a non-image area (a margin provided at edges of a recording sheet) of an image recording area.

The MFPs have various printing functions in addition to a normal printing function. For example, there is a card direct printing function for reading image data of images captured with a digital camera or the like stored in a memory card inserted into a memory card slot and for printing the image data on a recording sheet.

Additionally, there is a camera direct printing function for reading image data through a wired or wireless general-purpose interface directly connecting a digital camera and an MFP and for printing the image data on a recording sheet.

As in the case of the copy function, regarding printing functions, such as the card direct and camera direct printing functions, there are the following kinds of printing operations to be executed according to a result of processing executed on the read image data:
1) a normal printing operation for simply printing an image;
2) a (manual) repeated printing operation for repeatedly printing an image on recording sheets as many times as specified by an operator;
3) an (automatic) repeated printing operation for repeatedly printing an image as many times as the image can be recorded on recording sheets;
4) a mirror image printing operation for printing a mirror image while inversing the image;
5) an auto scaling printing operation for automatically determining a scaling factor to print an image on a whole recording sheet;
6) a marginless printing operation for printing an image on a whole recording sheet without providing a non-image area (a margin provided at edges of a recording sheet) of an image recording area; and
7) a label printing operation for printing an image on a label of a CD or the like.

The details of the marginless copy and marginless printing operations listed as the copy function (6) and the printing function (6), respectively, are disclosed in the following documents.

For example, according to Japanese Patent Laid-Open No. 2004-104190, a document image can be recorded on a recording sheet using a marginless copy mode for recording the image on the recording sheet after enlarging the image scanned from a document with an image scanning apparatus at a predetermined scaling factor.

More specifically, Japanese Patent Laid-Open No. 2004-104190 discloses a configuration that allows a user to set an overrunning amount, which corresponds to a size of an image not to be recorded on a recording sheet because the image overruns from the recording sheet due to enlargement of the document image, and that determines a scaling factor of an enlargement operation based on the overrunning amount set by the user.

In addition, for example, Japanese Patent Laid-Open No. 2006-167965 discloses a marginless printing method for printing an image on a label-side surface of an optical disc, such as a CD-R (label printing).

More specifically, image data can be printed on a whole label-side surface of a disc by partially enlarging the image data.

As described above, the marginless copy and marginless printing operations are realized by enlarging a whole document image or only a part of image data so that the document image becomes larger than a size of a recording sheet.

However, the above-described marginless copy and marginless printing operations have some disadvantages. For example, since a document image is enlarged to become larger than a size of a recording sheet, an output image undesirably becomes larger than the input image consequently or information at edges of the output image is not printed on the recording sheet and is lost.

As a result, for example, an output image resulting from enlargement of a document image in a first copy operation is further enlarged in a following copy operation when the marginless copy operation is repeated.

In addition, if a direct marginless printing operation is employed, a content of an image is changed and image information at edges is lost. For example, a central portion of an output image becomes larger than an image confirmed on a user interface (UI) screen of an MFP or a digital camera.

A similar phenomenon occurs when an aspect ratio differs between an input image and a recording sheet, as is seen in a case where an aspect ratio of an image captured with a digital camera is 4:3 and an aspect ratio of a standard recording sheet is 5:3.5. More specifically, when the image is enlarged to cover a whole recording sheet, an information loss ratio is higher on a shorter-edge side than on a longer-edge side since the aspect ratio of the image captured with the digital camera 4:5 is equivalent to 5:3.75.

Furthermore, when top, bottom, left, and right marginless widths of a recording sheet differ from one another, the information loss ratio tends to increase since a document image is enlarged based on a larger width of the vertical or horizontal marginless widths while setting a center of the document image at a center of the recording sheet.

On the other hand, when a document image is simply enlarged to cover an area defined by the size of a recording sheet+the marginless widths, which differ in the top, bottom, left, and right directions, the center of the original image is shifted from the center of the recording sheet, which leads to a change in a content of the image. As a result, an amount of difference between the centers for the number of times of repetition of the marginless copy operation accumulates, which increases the change in the content of the image.

### SUMMARY OF THE INVENTION

According to an aspect of the present invention, an information loss at edges is reduced while a change in a content of an image being suppressed at the time of a marginless copy operation or a marginless printing operation.

According to an aspect of the present invention, an image processing apparatus for processing an input image and generating an output image to be recorded on a recording medium includes a first obtaining unit configured to obtain a size of the input image, a second obtaining unit configured to obtain a size of the recording medium, a setting unit configured to set, in each of two directions orthogonal to each other, an overrunning amount caused if the input image were recorded on the recording medium without providing a margin, a dividing unit configured to divide the input image into a plurality of areas, a calculating unit configured to calculate a scaling factor of each of the plurality of divided areas in each of the two directions using the size of the recording medium, the overrunning amount, and the size of the input image, and a generating unit configured to perform a scaling operation on the each of the plurality of areas in the two directions based on the respective scaling factors to generate an output image.

According to the aspect of the present invention, an information loss at edges of an image can be reduced while a change in a content of an image being suppressed at the time of a marginless copy operation or a marginless printing operation.

An aspect of the present invention provides a new function. Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 illustrates a system configuration of an image processing apparatus (an MFP 100) according to an exemplary embodiment of the present invention.

FIG. 2 illustrates a configuration of an operation panel of an image processing apparatus (an MFP 100) according to an exemplary embodiment of the present invention.

FIG. 3 illustrates a configuration of major elements of an image scanning unit of an MFP 100.

FIG. 4 is a flowchart showing a flow of an entire operation executed in an MFP 100.

FIG. 5 shows copy modes that can be executed by an MFP 100.

FIG. 6 is a flowchart showing a flow of a marginless copy operation.

FIGS. 7A to 7C show layout of a document and a recording area at the time of execution of a marginless copy operation.

FIGS. 8A to 8C show an image loss ratio resulting from a marginless copy operation.

FIG. 9 is a flowchart showing a flow of a marginless copy operation.

FIGS. 10A to 10C show layout of a document and a recording area at the time of execution of a marginless copy operation.

FIGS. 11A to 11C show an image loss ratio resulting from a marginless copy operation.

FIG. 12 is a flowchart showing a flow of a marginless copy operation.

FIGS. 13A and 13B show layout of a document and a recording area and an image loss ratio at the time of execution of a marginless copy operation.

### DESCRIPTION OF THE EMBODIMENTS

Exemplary embodiments of the present invention will be described below with reference to the accompanying drawings. It is obvious that configurations (relative arrangement and sizes of elements, display screens, or the like) of exemplary embodiments described below do not intend to limit the scope of the present invention unless otherwise noted.

Hereinafter, a multifunction peripheral (MFP) collectively having an image scanning function, a direct printing function, a fax sending function, and a copy function will be described below as an exemplary embodiment of an image processing apparatus.

### First Exemplary Embodiment

### 1. System Configuration of Image Processing Apparatus

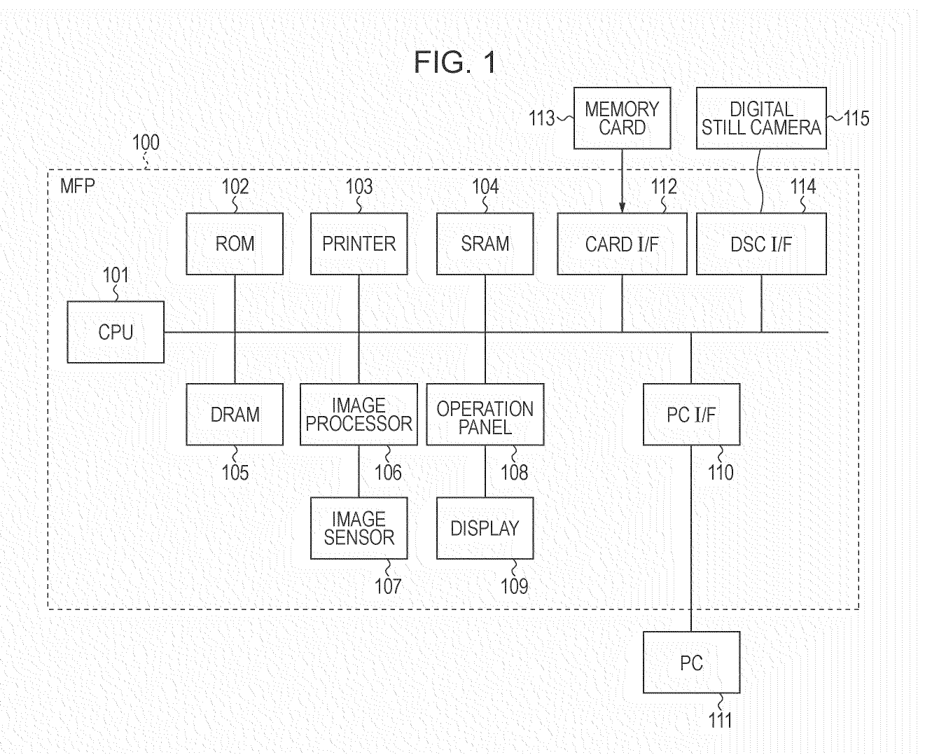

FIG. 1 illustrates a system configuration of an image processing apparatus (an MFP 100) according to a first exemplary embodiment of the present invention. Referring to FIG. 1, a central processing unit (CPU) 101 serves as a system control unit of the MFP 100 and controls each block constituting the MFP 100.

A read-only memory (ROM) 102 stores system control programs of the MFP 100. The CPU 101 executes various kinds of processing regarding the MFP 100 on the basis of the control programs stored in the ROM 102. Such control programs executed by the CPU 101 may be stored in an external storage medium, such as a flexible disk or a CD-ROM, in addition to the ROM 102. In addition, the control programs may be loaded to a random access memory (RAM), for example, an SRAM 104, of the MFP 100 by a dedicated reader, and decoded and executed by the CPU 101.

A printer 103 has a function for recording scanned or input image data on a recording sheet. The printer 103 employs a given image recording method (an electrophotographic method, an inkjet method, or the like).

The SRAM 104 is mainly used for storing data registered in the MFP 100. A DRAM 105 is mainly used for storing image data.

An image processor 106 performs various kinds of image processing (scaling of an image, conversion of an image into data of a predetermined image format, or the like) on image data scanned by an image sensor 107.

The image sensor 107 scans a document image and includes a contact scan sensor.

An operation panel 108 includes a display 109 for displaying a status of the apparatus. The operation panel 108 is used for receiving operation instructions entered by an operator and registration of various kinds of data.

A personal computer (PC) interface (I/F) 110 connects the MFP 100 and a PC 111. The PC 111 utilizes the MFP 100 as a peripheral and functions as a host computer that changes various kinds of setting data of the MFP 100 and requests activation of various operations.

A card I/F 112 connects the MFP 100 and a memory card 113. The memory card 113 functions as an external storage device of the MFP 100. The MFP 100 has a card direct printing function for printing image data using the printer 103 after receiving the image data, such as photograph images stored in the memory card 113, through the card I/F 112.

A digital still camera (DSC) I/F 114 connects the MFP 110 and a DSC 115 with a cable or wirelessly. The MFP 100 has a camera direct printing function for printing image data using the printer 103 after receiving the image data, such as photograph images stored in the DSC 115, through the DSC I/F 114.

The DSC 115 is logically connected to the MFP 100 according to a camera direct print protocol and allows the MFP 100 to function as a print service providing apparatus. In addition, the DSC 115 allows the MFP 100 to function as a print service utilizing apparatus capable of changing various kinds of setting data defined by the direct print protocol and requesting activation of various operations.

Meanwhile, the image processor 106 also performs various kinds of image processing (scaling of an image, conversion of an image into data of a predetermined image format, or the like) on image data received through the card I/F 112 and the DSC I/F 114.

### 2. Configuration of Operation Panel of Information Processing Apparatus

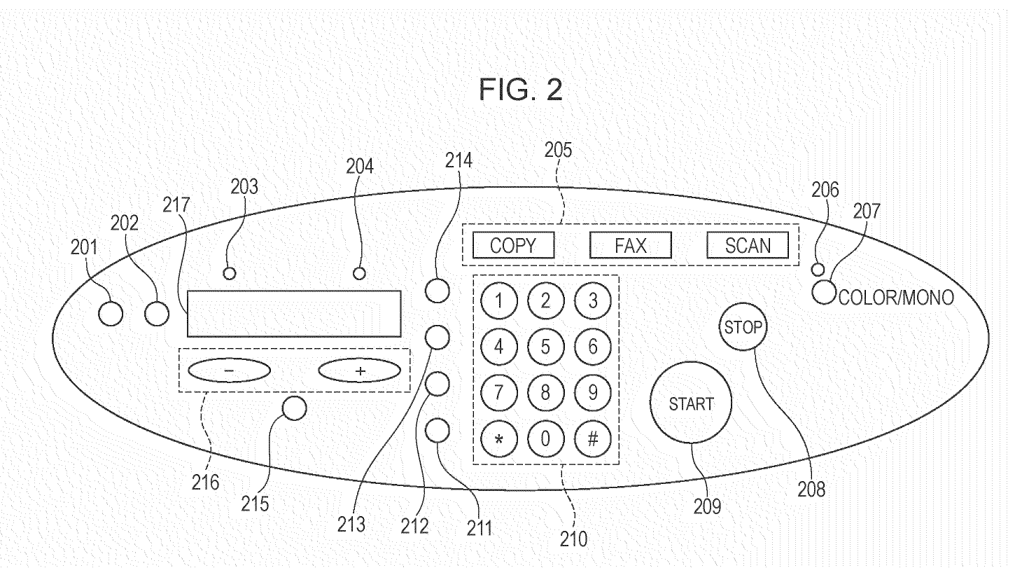

FIG. 2 illustrates a configuration of an operation panel of an image processing apparatus (MFP 100) according to the first exemplary embodiment of the present invention. A configuration of an operation panel will be described below with reference to FIG. 2.

A power key 201 is used for turning the MFP 100 ON/OFF. A recovery key 202 is for canceling an error of the MFP 100.

A memory usage display LED 203 indicates a usage state of an image memory (DRAM 105). Blinking of the memory usage display LED 203 indicates that the MFP 100 is using the image memory.

An error display LED 204 is for error display. Blinking of the error display LED 204 indicates that the MFP 100 is in an error state.

A mode switch key 205 is for switching a mode of the MFP 100 from a standby mode to a copy mode, a FAX mode, a scan mode, or a direct print mode.

Internally, there are two direct print modes, a card direct print mode and a camera direct print mode. The mode is switched into the direct print mode basically, but not limited to, with the mode switch key 205. For example, the mode may be switched upon the DSC I/F 114 detecting connection of the DSC 111 or upon the card I/F 112 detecting insertion of the memory card 113.

A color mode display LED 206 is for displaying a mode regarding color processing of an image. An ON state of the color mode display LED 206 indicates that the MFP 100 is in a color scanning mode.

A scan mode can be switched between a color mode and a monochrome mode with a color/monochrome switch key 207. The color mode display LED 206 is turned ON when the scan mode is set to the color mode, whereas the color mode display LED 206 goes out in the monochrome mode.

A stop key 208 is for stopping an operation of the MFP 100. A start key 209 is for starting an operation of the MFP 100.

A numeral keypad 210 is used for inputting numerals, such as a number of sheets to be copied and a facsimile number of a communication target.

An image quality mode, e.g., an image quality of a copied image (or a faxed image), is switched with a copy image quality selection key 211. In addition, a copy contrast is adjusted with a copy contrast adjustment key 212.

A recording sheet size selection key 213 is used for selecting the size of a recording sheet set in the printer 103. A copy scaling factor of the MFP 100 is set with a copy scaling factor setting key 214.

A set key 215 is used to determine settings in various kinds of registration modes. The various settings can be displayed on a display 217 using a menu key 216.

The display 217 corresponds to the display 109 shown in FIG. 1. The display 217 may be a liquid crystal display or the like.

### 3. Configuration of Major Elements of Image Scanning Unit

FIG. 3 illustrates a configuration of major elements of an image scanning unit of the MFP 100. As shown in FIG. 3, the image scanning unit of the MFP 100 according to the exemplary embodiment of the present invention can utilize two image scanning methods, namely, an auto document feeder (ADF) scanning method and a flatbed scanning method.

Referring to FIG. 3, the image scanning units for the ADF scanning method and the flatbed scanning method share some members (an image sensor and a black-and-white reference plate in this exemplary embodiment) except for members used for conveying a document. In FIG. 3, a black-and-white reference plate 310 is arranged at a lower part of a platen 307 and generates shading data of an image sensor 306. The black-and-white reference plate 310 has two kinds of colored portions, namely, white portions and black portions. Shading data of respective colors can be obtained by turning a light source (not shown) of the image sensor 306 ON/OFF under the image sensor 306 after moving the image sensor 306 under the black-and-white reference plate 310.

A document set position 309 is a reference set position for correctly placing a document on the platen 307.

A pressure plate 311 is a cover for preventing outside light from entering at the time of scanning of a document. An inner side of the pressure plate 311 is formed of a white sheet.

The image sensor 306 is arranged under the platen 307 made of transparent glass. The image sensor 306 is driven by a driving unit, not shown, to scan an image of a document 308 placed on the platen 307. When the apparatus is in a standby state (excluding a case where the ADF scanning method is selected), the image sensor 306 stands by at an image sensor home position 305.

The image sensor 306 and the black-and-white reference plate 310 are also used when a document is scanned using an ADF.

An ADF scanning unit is arranged at one end of the platen of such a flatbed scanning unit. The ADF scanning unit may be initially included in the apparatus or may be removably attached as an optional part.

The ADF scanning unit has a conveying unit 312, which may be a roller for conveying a document one by one from a document set position 301 to a document discharge position 303. An image of an automatically conveyed document is scanned by moving the image sensor 306 at an ADF scanning position 304 provided under the conveying unit 312.

A document detecting sensor 302, which may be an optical sensor or a limit switch, is provided at an end of the document set position 301 of the ADF scanning unit. The document detecting sensor 302 can detect existence or absence of a document placed at the document set position 301.

When the document detecting sensor 302 detects a document, it is considered that the ADF scanning method is selected and an ADF scanning operation is performed in response to a predetermined operation (an operation on the start key 209 shown in FIG. 2) instead of using the flatbed scanning method.

During the ADF scanning operation, the image sensor 306 moves to the ADF scanning position 304 and scans a part of an image of a document passing over the ADF scanning position 304 while the conveying unit 312 conveying the document to the document discharge position 303.

When the document detecting sensor 302 does not detect a document and it is determined that the ADF scanning method is not selected (by other explicit operations), the flatbed scanning method is selected. If the flatbed scanning method is selected, the image sensor 306 returns to the image sensor home position 305 and is in the standby state.

Meanwhile, according to the configuration of the ADF scanning unit shown in FIG. 3, it is difficult for the conveying unit 312 to convey a document in the opposite direction (even if it is possible, a complex, expensive, and unreal configuration is often required). Accordingly, when the ADF scanning method is selected, a pre-scan operation is not performed (for the purpose of detection of the size of a document).

In addition, automatic conveyance of a document by the ADF scanning unit shown in FIG. 3 is not suitable for a marginless copy operation described below. This is because it is difficult to obtain such conveyance accuracy due to restrictions regarding a production cost although sufficient conveyance accuracy has to be obtained in order to extremely strictly control oblique feeding of a document and accurately scan a whole document in the marginless copy operation.

As described above, the MFP 100 shown in FIGS. 1 to 3 can perform operations, such as a direct print operation, an image scanning operation, a copy operation, and a fax sending operation. In the MFP 100 according to the exemplary embodiment, selection of the image scanning methods is controlled according to the copy modes, particularly, whether detection of the document size is needed or whether scanning of a whole document (marginless copy operation) is needed.

### 4. Flow of Operation in Image Processing Apparatus

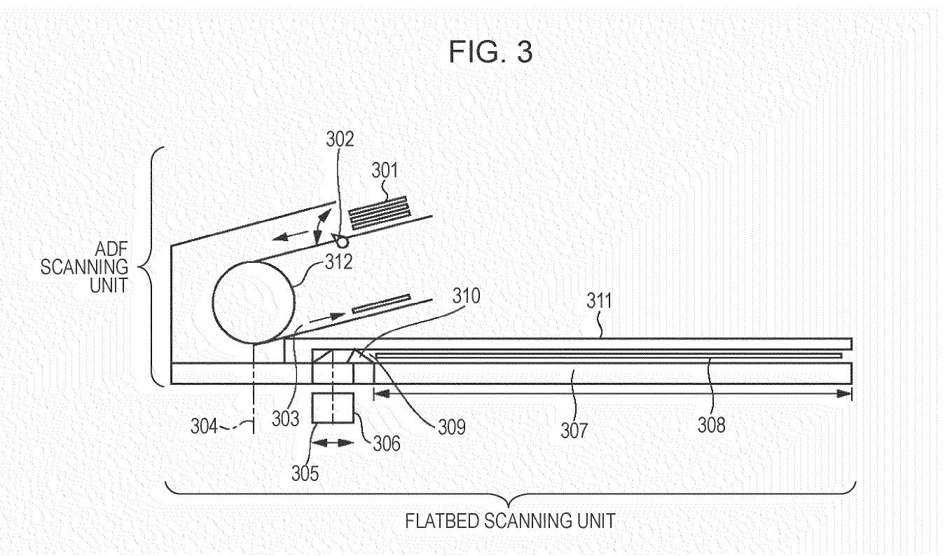

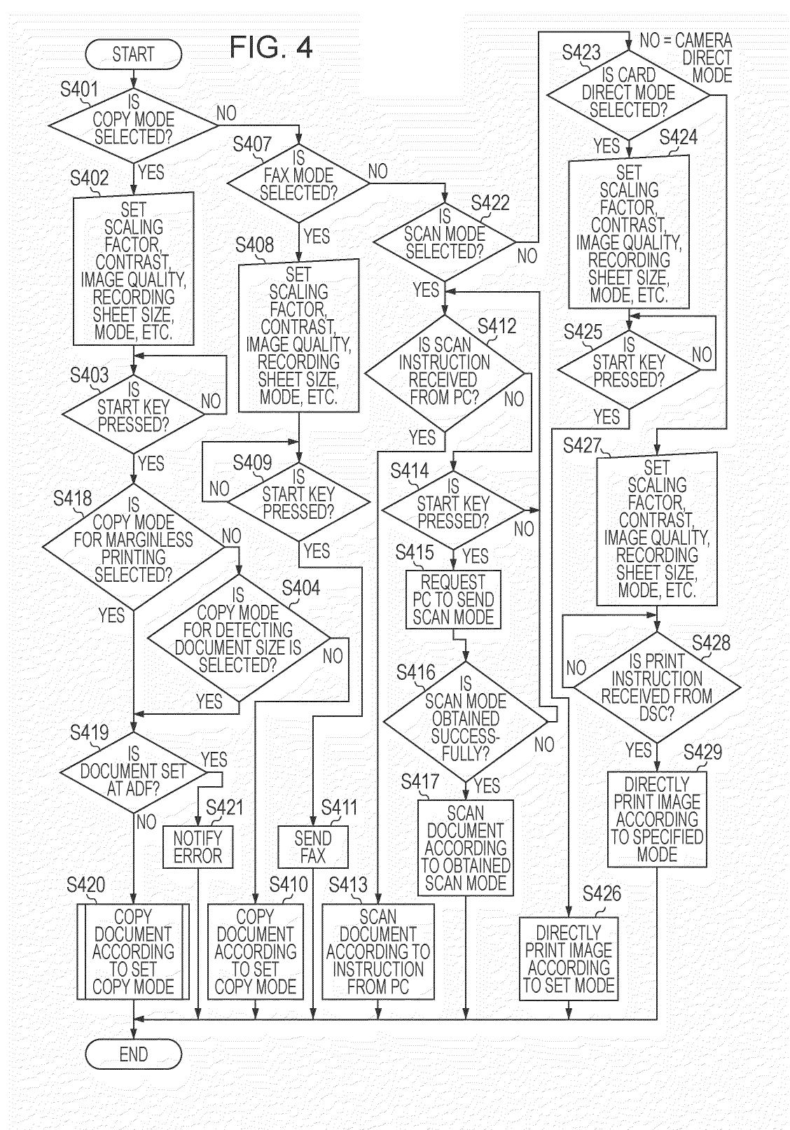

An operation executed by the CPU 101 will be described below with reference to FIG. 4. FIG. 4 is a flowchart showing a flow of an operation executed by the CPU 101 of the MFP 100.

As shown in FIG. 4, the CPU 101 determines whether a copy mode is selected by checking a state of the mode switch key 205 at STEP S401. If the CPU 101 determines that the copy mode is selected, the process proceeds to STEP S402. At STEP S402, the CPU 101 waits for a copy instruction entered by an operator. On the other hand, if the CPU 101 determines that the copy mode is not selected, the process proceeds to STEP S407. At STEP S407, the CPU 101 determines whether a fax mode is selected.

If the CPU 101 determines that the fax mode is selected at STEP S407, the CPU 101 waits for a fax instruction entered by an operator at STEP S408. If the operator presses the start key 209 after setting a scaling factor, contrast, an image quality, a recording sheet size, and a mode, the CPU 101 detects this operation at STEP S409. The process then proceeds to STEP S411. At STEP S411, the CPU 101 sends a fax.

In addition, if the CPU 101 determines that the fax mode is not selected at STEP S407, the CPU 101 determines whether a scan mode is selected at STEP S422.

If the CPU 101 determines that the scan mode is selected at STEP S422, the process proceeds to STEP S412. At STEP S412, the CPU 101 waits for an image scan instruction sent from the connected PC 111. If the CPU 101 determines that the image scan instruction is received from the PC 111 at STEP S412, the process proceeds to STEP S413. At STEP S413, the CPU 101 scans an image according to the image scan instruction.

If the image scan instruction is not received from the PC 111, the CPU 101 determines whether the start key 209 is pressed at STEP S414. If the start key 209 is pressed, the process proceeds to STEP S415. At STEP S415, the CPU 101 requests the PC 111 to send a scan mode.

At STEP S416, the CPU 101 determines whether a predetermined scan mode is obtained successfully from the PC 111. If the CPU 101 determines that the scan mode is obtained successfully, the process proceeds to STEP S417. At STEP S417, the CPU 101 scans the image according to the obtained scan mode.

In addition, if the CPU 101 determines that the scan mode is not selected at STEP S422, the CPU 101 determines that a direct print mode is selected. At STEP S423, the CPU 101 further determines whether a card direct print mode is selected.

If the CPU 101 determines that the card direct print mode is selected at STEP S423, the process proceeds to STEP S424. At STEP S424, the CPU 101 waits for a card direct print instruction entered by an operator. If the operator presses the start key 209 after setting a contrast, an image quality, a recording sheet size, and a mode, the CPU 101 detects this operation at STEP S425. At STEP S426, the CPU 101 performs a card direct printing operation.

On the other hand, if the CPU 101 determines that the card direct print mode is not selected at STEP S423, the CPU 101 determines that a camera direct print mode is selected and the process proceeds to STEP S427. At STEP S427, the CPU 101 waits for a camera direct print instruction sent from the DSC 115. If an operator instructs start of a direct printing operation after setting a contrast, an image quality, a recording sheet size, and a mode, the CPU 101 detects this operation at STEP S428. At STEP S429, the CPU 101 performs a camera direct printing operation.

Meanwhile, in the fax mode (from STEP S407) and the scan mode (from STEP S412), the document size may be detected in a pre-scan operation, which will be described later. However, in this exemplary embodiment, the document size is not detected in the fax mode and the scan mode.

If the CPU 101 determines that the current state is the copy mode at STEP S401, the process proceeds to STEP S402. At STEP S402, the CPU 101 receives an operator's copy settings, such as a scaling factor, a contrast, an image quality, a recording sheet size, and a copy mode. At STEP S403, the CPU 101 detects the operator's pressing of the start key 209 (corresponding to a second obtaining unit).

At STEP S418, the CPU 101 determines whether a marginless copy mode is set. If the CPU 101 determines that the marginless copy mode is not set, the process proceeds to STEP S404. At STEP S404, the CPU 101 determines whether the copy mode is set to a document size detection mode.

At STEP S404, if the CPU 101 determines that the copy mode is not set to the pre-scan document size detection mode, the process proceeds to STEP S410. At STEP S410, the CPU 101 performs a copy operation without detecting the document size according to the selected copy mode (e.g., performs the copy operation using a recording sheet of a set size).

If the CPU 101 determines that the marginless copy mode is selected at STEP S418, the process proceeds to STEP S419. Alternatively, if the CPU 101 determines that the copy mode is set to the pre-scan document size detection mode (by a first obtaining unit) at STEP S404, the process proceeds to STEP S419. Meanwhile, a case of YES of STEP S418 or STEP S404 indicates that a marginless copy mode requiring scanning of a whole document or a copy mode requiring detection of a document size is selected.

As described above, the ADF scanning method is not suitable for those copy modes. Accordingly, at STEP S419, the CPU 101 determines whether a document is set at the ADF scanning unit. If the CPU 101 determines that the document is set, the process proceeds to STEP S421.

Here, YES of STEP S419 indicates that the ADF scanning method is selected regardless of necessity of scanning of a whole document or a pre-scan operation and thus a successful scan operation cannot be performed. Accordingly, at STEP S421, the CPU 101 warns a user about an error. For example, the CPU 101 visually displays a message “Please remove a document from the ADF and select the flatbed scanning method” on the display 217 or outputs sound from a speaker to warn the error.

On the other hand, if the CPU 101 determines that the document is not set at the ADF scanning unit, that is, the flatbed scanning method is selected, at STEP S419, the process proceeds to STEP S420. At STEP S420, the CPU 101 performs a marginless copy operation involving scanning of a whole document or a copy operation involving detection of a document size, which will be described later. Meanwhile, selection of the image scanning methods can be readily, inexpensively, and directly detected by detecting existence or absent of a document at the document set position 301 of the ADF scanning unit using the document detecting sensor 302. Whether to perform the pre-scan document size detection differs depending on a copy mode (copy type).

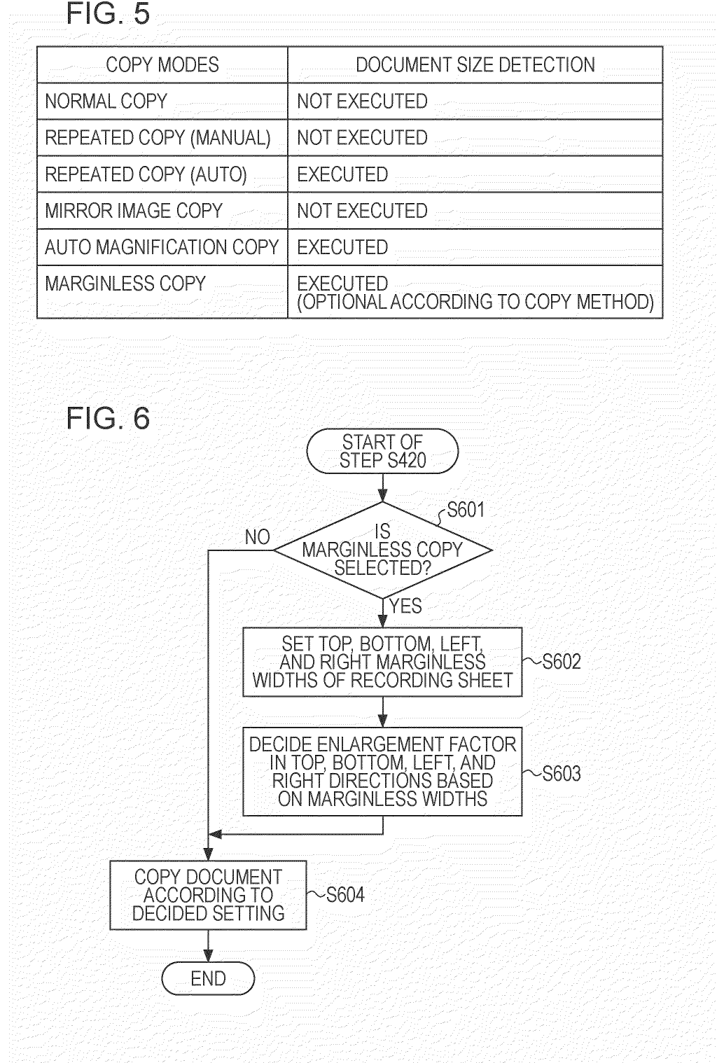

Here, the MFP 100 according to the exemplary embodiment can perform six kinds of copy operations shown in FIG. 5. The detail of each copy operation is as follows:
1) a normal copy operation for simply copying a document;
2) a (manual) repeated copy operation for repeatedly copying a document on recording sheets as many times as specified by an operator;
3) an (automatic) repeated copy operation for repeatedly copying a document as many times as the image of document can be recorded on recording sheets after determining a size of the document by performing a pre-scan operation;
4) a mirror image copy operation for copying a mirror image of a document while inversing an image of the document;
5) an auto scaling copy operation for automatically deciding a scaling factor to copy a document on a whole recording sheet after determining a size of the document by performing a pre-scan operation; and
6) a marginless copy operation for copying a document on a whole recording sheet without providing a non-image area (a margin provided at edges of a recording sheet) of an image recording area.

In the exemplary embodiment, three kinds of copy operations, namely, 3) the (automatic) repeated copy operation, 5) the auto scaling copy operation, and 6) the marginless copy operation, include the pre-scan document size detection. However, the detection of the document size is not mandatory in the marginless copy operation depending on the copy control method.

In 3) the (automatic) repeated copy operation, 5) the auto scaling copy operation, and 6) the marginless copy operation (employing the document size detection), the MFP 100 performs a pre-scan operation before scanning an image. Through the pre-scan operation, the MFP 100 determines the document size.

### 5. Detail of Copy Operation (STEP S420)

### 5.1 Flow of Marginless Copy Operation

A marginless copy operation, among copy operations executed at STEP S420, will now be described in detail with reference FIGS. 6 to 8C.

The MFP 100 according to the exemplary embodiment sets marginless widths in the top, bottom, left, and right directions (in two directions orthogonal to each other) at the time of the marginless copy operation. The MFP 100 sets enlargement factors (scaling factors) in respective directions from a center of an original image, thereby reducing an image loss ratio while setting the center of the original image at a center of the original image formed on a recording sheet.

At STEP S601 shown in FIG. 6, the CPU 101 determines whether a currently set copy mode is the marginless copy mode. If the marginless copy mode is selected, the CPU 101 performs processing of STEPs S602 to S604.

At STEP S602, the CPU 101 sets top, bottom, left, and right marginless widths for a size of a recording sheet set by an operator at STEP S402 shown in FIG. 4. In this exemplary embodiment, for example, the top, bottom, left, and right marginless widths of approximately 4.5 mm, 8 mm, 3 mm, and 6 mm, respectively, are set for an L-size recording sheet. An important point is that the top, bottom, left, and right marginless widths of the recording sheet are determined according to a mechanical structure and a characteristic of the MFP 100 and do not necessarily indicate the same values.

For example, a description will be given for the MFP 100 that controls a recording position of a recording sheet based on detection of a top edge of the recording sheet. If the MFP 100 has sufficiently high accuracy in detection of the top edge of the recording sheet but has unpreferable conveyance accuracy, displacement becomes worse at the bottom edge of the recording sheet than at the top edge of the recording sheet.

Similarly, in the case of the MFP 100 having a guide on the left side of the recording sheet, position accuracy of the MFP 100 is higher on the left side of the recording sheet and displacement increases on the right side of the recording sheet when a recording sheet is fed obliquely.

At STEP S603, the CPU 101 determines enlargement factors in top, bottom, left, and right directions based on the marginless widths. The enlargement factors can be calculated using the following equations based on an obtained document size (image size), a recording sheet size (recording medium size), and the marginless widths.

Top Enlargement Factor=(Length between Recording Sheet Center and Top End of Recording Sheet+Top Marginless Width)/(Length between Original Image Center and Top End of Original Document)

Bottom Enlargement Factor=(Length between Recording Sheet Center and Bottom End of Recording Sheet+Bottom Marginless Width)/(Length between Original Image Center and Bottom End of Original Document)

Left Enlargement Factor=(Length between Recording Sheet Center and Left End of Recording Sheet+Left Marginless Width)/(Length between Original Image Center and Left End of Original Document)

Right Enlargement Factor=(Length between Recording Sheet Center and Right End of Recording Sheet+Right Marginless Width)/(Length between Original Image Center and Right End of Original Document)

Although calculation of four kinds of enlargement factors is described in this exemplary embodiment, the enlargement factors are actually applied to enlarged areas resulting from division of a recording sheet in nine areas, namely, upper left, upper, upper right, left, central, right, lower left, lower, and lower right areas with respect to the center of the original image formed on the recording sheet.

For example, in an upper left area with respect to the center of the original image formed on a recording sheet, the top enlargement factor is applied in the vertical direction, whereas the left enlargement factor is applied in the horizontal direction. In an upper area with respect to the center of the original image formed on a recording sheet, the top enlargement factor is applied in the vertical direction.

After determining the enlargement factors at STEP S603, the CPU 101 performs an enlargement operation (scaling operation) based on the determined enlargement factors to copy a document at STEP S604.

### 5.2 Result of Marginless Copy Operation

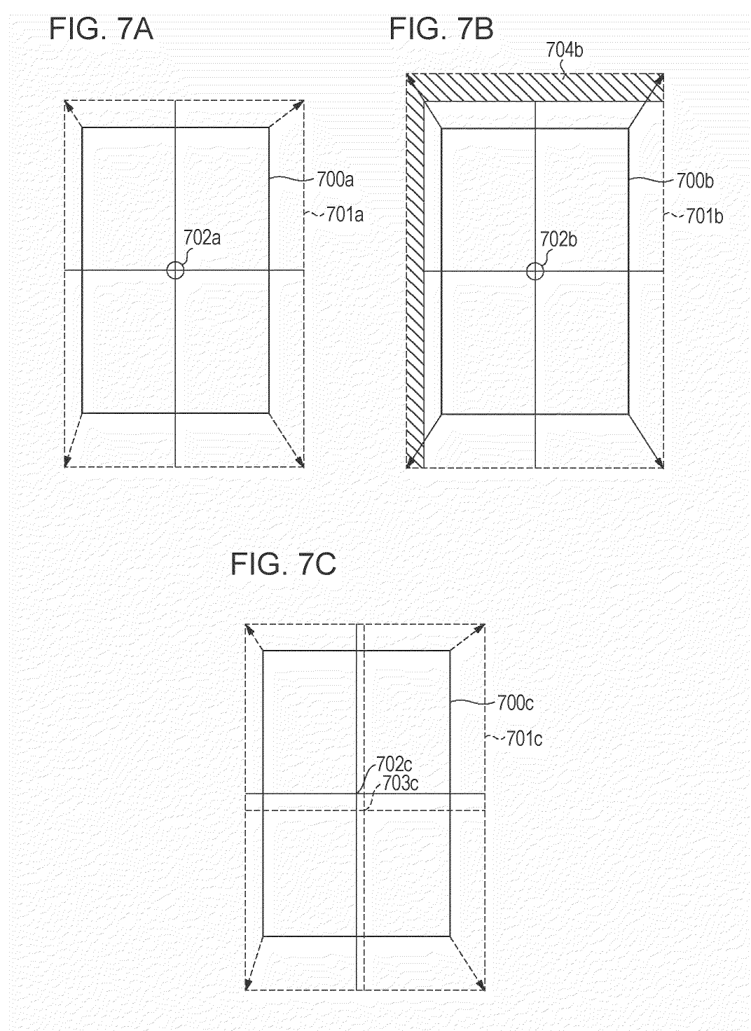

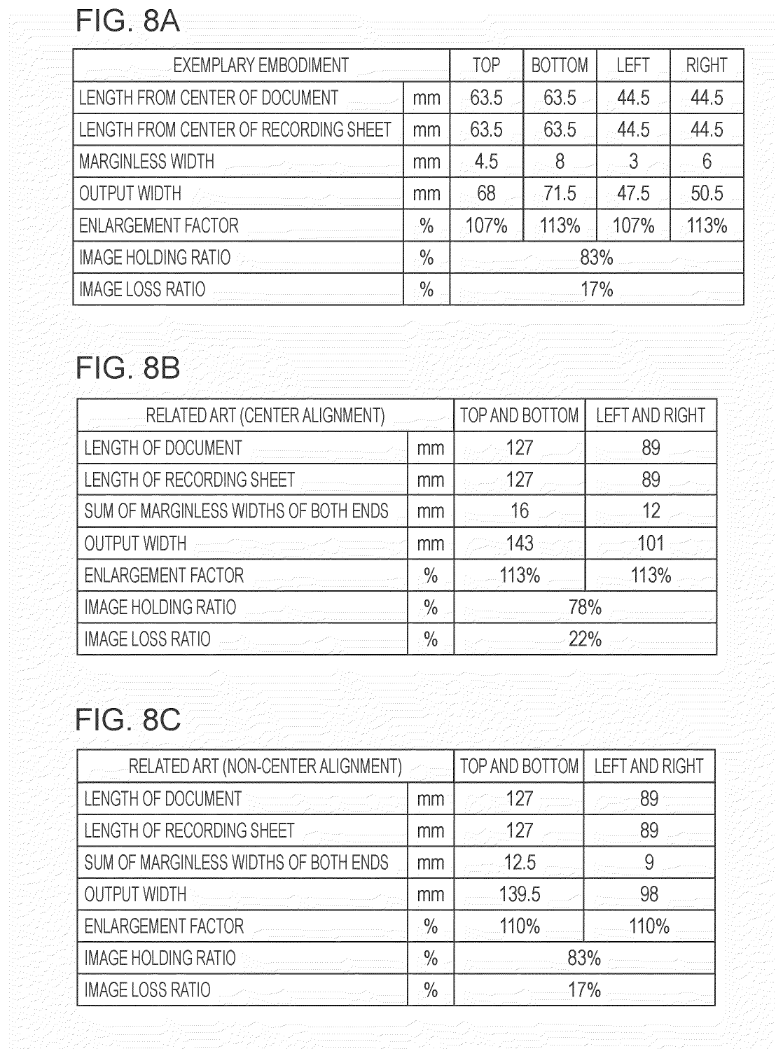

Layout of an original document and a recording sheet at the time of execution of a marginless copy operation and a difference in an image loss ratio of this case (a difference between a processing result in the MFP 100 according to this exemplary embodiment and a processing result in an MFP according to the related art) will now be described with reference to FIGS. 7A to 8C.

FIG. 7A shows layout of an original image and a recording area when the MFP 100 according to the exemplary embodiment is used. FIG. 7B shows layout of an original image and a recording area when the center of the original image is set at the center of the original image formed on a recording sheet according to the related art. FIG. 7C shows layout of an original image and a recording area when the center of the original image is not set at the center of the original image formed on a recording sheet according to the related art.

FIG. 8A shows an image loss ratio obtained when the MFP 100 according to this exemplary embodiment is used. FIG. 8B shows an image loss ratio obtained when the center of the original image is set at the center of the original image formed on a recording sheet according to the related art. FIG. 8C shows an image loss ratio obtained when the center of the original image is not set at the center of the original image formed on a recording sheet according to the related art.

### 5.2.1 Image Loss Ratio in MFP 100

First, layout employed when the MFP 100 according to this exemplary embodiment is used and an image loss ratio obtained at that time will be described in detail.

In FIG. 7A showing a layout example employed when the MFP 100 according to the exemplary embodiment is used, a thick solid line 700a shows a size of a document, whereas a thick broken line 701a shows a size of a recording area (a size obtained by adding marginless widths to a recording sheet size). In addition, a circle 702a shows a center of an original image and a center of the original image formed on the recording sheet.

FIG. 8A shows an image loss ratio obtained when the MFP 100 according to the exemplary embodiment is used for such a layout. Meanwhile, the image loss ratio is calculated for an L-size document and obtained vertical and horizontal document sizes are 127 mm and 89 mm, respectively. Accordingly, a length from the center of the original image to the top or bottom edge is 63.5 mm, whereas a length from the center of the original image to the left or right edge is 44.5 mm. In addition, since the size of the recording sheet is also the L-size, lengths from a center of an original image formed on a recording sheet are the same as the above-described lengths from the center of the original image.

The MFP 100 according to the exemplary embodiment sets enlargement factors based on respective marginless widths in top, bottom, left, and right directions with respect to the center of the original image so that a pixel at the center of the original image is not moved. Accordingly, in the above-described case, the top, bottom, left, and right marginless widths are 4.5 mm, 8 mm, 3 mm, and 6 mm, respectively, in FIG. 8A.

Recording area widths (output widths) are equal to values obtained by adding the marginless widths of respective directions to the lengths from the current image center of the recording sheet to the top, bottom, left, and right edges. For example, a top recording area width 68 mm=the length of the recording sheet from the center of the original image to the top edge 63.5 mm+the top marginless width 4.5 mm.

The enlargement factor is a value obtained by dividing the recording area width by the length from the center of the original image. Accordingly, the top, bottom, left, and right enlargement factors are 107%, 113%, 107%, and 113%, respectively.

An image holding ratio represents a ratio of an image recorded on a recording sheet to an original image enlarged in the top, bottom, left, and right directions at the enlargement factors.

Image Holding Ratio=(Size of Document: 127 mm×89 mm)/(Top Output Width 68 mm+Bottom Output Width 71.5 mm)×(Left Output Width 47.5 mm+Right Output Width 50.5 mm)

Since the image holding ratio is equal to 83% in this exemplary embodiment, the image loss ratio is equal to 100%−83%=17%.

That is, 17% of information of an original image is arranged outside of a recording sheet and is lost.

5.2.2 Image Loss Ratio (1) according to Related Art

Layout employed when the center of an original image matches the center of the original image formed on a recording sheet and an image loss ratio obtained at that time in an MFP according to the related art will now be described in detail.

Referring to FIG. 7B, a thick solid line 700b shows a size of a document, whereas a thick broken line 701b shows a size of a recording area. In addition, a circle 702b shows a center of an original image and a center of the original image formed on the recording sheet. A shaded area 704b is a difference between the recording area sizes 701b and 701a shown in FIGS. 7B and 7A, respectively.

FIG. 8B shows an image loss ratio obtained when the center of the original image is set to match the center of the original image formed on the recording sheet using such layout according to the related art. Meanwhile, as in the case of calculation of the image loss ratio in the MFP 100 according to the exemplary embodiment, the image loss ratio is also calculated for an L-size document and vertical (top and bottom) and horizontal (left and right) document sizes are 127 mm and 89 mm, respectively. In addition, since the size of the recording sheet is also the L-size, lengths of the recording sheet are the same as those of the document described above.

The MFP according to the related art sets a constant enlargement factor when the center of the original image is set to match the center of the original image formed on the recording sheet so that the image covers the marginless areas in all directions. More specifically, the MFP employs the same values regarding top and bottom marginless widths and regarding left and right marginless widths as the vertical and horizontal marginless widths. Accordingly, the vertical and horizontal marginless widths shown in FIG. 7B are set equal to 8 mm and 6 mm, respectively, based on the above-described values. Sums of the vertical and horizontal marginless widths of the both ends are equal to 16 mm and 12 mm, respectively.

Recording area widths are equal to values obtained by adding the sum of the marginless widths of both ends of the respective directions to the vertical and horizontal lengths of the recording sheet. For example, a vertical recording area width 143 mm=the vertical length of the recording sheet 127 mm+the sum of vertical marginless width of both ends 16 mm.

The enlargement factor is a value obtained by dividing the recording area width by the length of the document. As a result, the vertical and horizontal enlargement factors are 113% and 113%, respectively.

Accordingly, an image holding ratio is determined by the following equation.

Image Holding Ratio=(Size of Document 127 mm×89 mm)/(Vertical Output Width 143 mm×Horizontal Output Width 101 mm)

More specifically, the image holding ratio obtained in the MFP according to the related art is equal to 78% when the center of the original image is set to match the center of the original image formed on the recording sheet. Thus, the image loss ratio is equal to 100%−78%=22%.

5.2.3 Image Loss Ratio (2) according to Related Art

Layout employed when the center of an original image does not match the center of the original image formed on a recording sheet and an image loss ratio obtained at that time in an MFP according to the related art will now be described in detail.

Referring to FIG. 7C, a thick solid line 700c shows a size of a document, whereas a thick broken line 701c shows a size of a recording area. In addition, a point 702c shows a center of an original image, whereas a point 703c shows a center of the original image formed on the recording sheet.

FIG. 8C shows an image loss ratio obtained using such layout when the centers of the original images do not match according to the related art. Meanwhile, the image loss ratio is also calculated for an L-size document and vertical and horizontal document sizes are 127 mm and 89 mm, respectively. In addition, since the size of the recording sheet is also the L-size, lengths of the recording sheet are the same as those of the document described above.

The MFP according to the related art sets a constant enlargement factor when the center of the original image is set not to match the center of the original image formed on the recording sheet so that the image covers the marginless areas in all directions. More specifically, when the same top, bottom, left, and right marginless widths as those employed in the exemplary embodiment are used, the top, bottom, left, and right marginless widths are equal to 4.5 mm, 8 mm, 3 mm, and 6 mm. Sums of the vertical and horizontal marginless widths of the both ends are equal to 12.5 mm and 9 mm, respectively, in FIG. 7C.

Recording area widths are equal to values obtained by adding the sum of the marginless widths of both ends of the respective directions to the vertical and horizontal lengths of the recording sheet. For example, a vertical recording area width 139.5 mm=the vertical length of the recording sheet 127 mm+the sum of vertical marginless widths of both ends 12.5 mm.

The enlargement factor is a value obtained by dividing the recording area width by the length of the document. As a result, the vertical and horizontal enlargement factors are 110% and 110%, respectively.

Accordingly, an image holding ratio is determined by the following equation.

Image Holding Ratio=(Size of Document 127 mm×89 mm)/(Vertical Output Width 139.5 mm×Horizontal Output Width 98 mm).

More specifically, when the center of the original image does not match the center of the original image formed on the recording sheet, the image holding ratio is equal to 83% in the related art. The image loss ratio is thus equal to 100%−83%=17%.

### 5.3 Comparison of Marginless Copy Results

As is clear from the layout shown in FIGS. 7A and 7B and the image loss ratios shown in FIGS. 8A and 8B, the image loss ratio obtained in the MFP according to the related art is equal to 22% when the center of the original image matches the center of the original image formed on a recording sheet. On the other hand, the image loss ratio obtained in the MFP 100 according to the exemplary embodiment is equal to 17%. Thus, the image loss ratio can be improved by 5% (=22%-17%). This indicates that approximately 23% of an image that is lost when the MFP according to the related art is used can be held on a recording sheet.

In addition, as is clear from the layout shown in FIGS. 7A and 7C and the image loss ratios shown in FIGS. 8A and 8C, the image loss ratio obtained by using the MFP 100 according to the exemplary embodiment is equal to 17%, which is the same as that obtained by using the MFP according to the related art. However, the MFP 100 according to the exemplary embodiment can realize a state in which the center of the original image matches the center of the original image formed on a recording sheet.

In contrast, when the center of the original image does not match the center of the original image formed on the recording sheet, a half of a difference between the vertical and horizontal marginless widths appears as displacement of the center position in the MFP according to the related art. More specifically, the center position is shifted in the downward direction by 1.75 mm (=(bottom marginless width 8 mm−top marginless width 4.5 mm)÷2) and in the right direction by 1.5 mm (=(right marginless width 6 mm−left marginless width 3 mm)÷2).

As described above, the MFP 100 according to the exemplary embodiment performs a marginless copy operation after setting the marginless width in each of top, bottom, left, and right directions and enlargement factors in respective directions from the center of the original image. This allows the image loss ratio to be reduced while setting the center of the original image to match the center of the original image formed on the recording sheet.

Meanwhile, the enlargement factors of the top, bottom, left, and right directions may be increased according to a distance from the center of the original image.

In this exemplary embodiment, the same values are employed regarding the top, bottom, left, and right marginless widths. More specifically, the top, bottom, left, and right marginless widths are equal to 4.5 mm, 8 mm, 3 mm, and 6 mm, respectively. Accordingly, when an original image is copied from an L-size document to an L-size recording sheet, the vertical enlargement factor is substantially equal to the horizontal enlargement factor.

However, advantages of the exemplary embodiment of the present invention are not limited to such a case. The image loss ratio can be reduced while setting the center of the original image to match the center of the original image formed on the recording sheet regarding combinations of marginless widths, a document size, and a recording sheet size that give different vertical and horizontal enlargement factors.

### Second Exemplary Embodiment

In the first exemplary embodiment, the description has been given for a case where enlargement factors are set in respective directions from a center of an original image. However, when enlargement factors based on marginless widths are set in top, bottom, left, and right directions as in the case of the first exemplary embodiment, the entire image may be distorted since the enlargement factors differ in each direction from the center of the original image.

Additionally, there is no difference in the image loss ratio between a method according to the first exemplary embodiment and a method for setting the center of the original image not to match the center of the original image formed on the recording sheet using an MFP according to related art.

Accordingly, in this exemplary embodiment, a description will be given for a case of further reducing an image loss ratio while avoiding occurrence of distortion of an image by providing a non-marginless enlarged area.

Meanwhile, since a system configuration of an MFP 100, a configuration of an operation panel, and a configuration of major elements of an image scanning unit are the same as those of the first exemplary embodiment, a description thereof is omitted here.

### 1. Detail of Copy Operation

### 1.1 Flow of Marginless Copy Operation

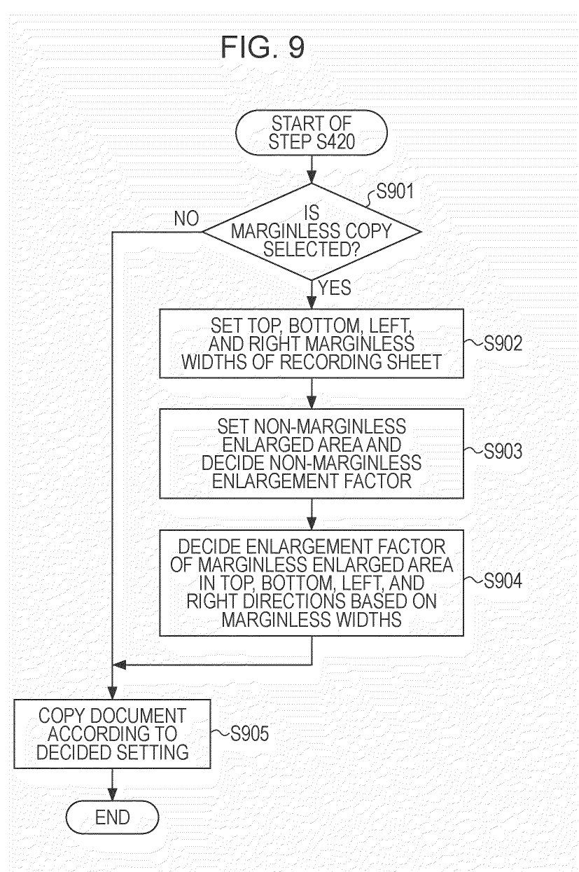

FIG. 9 is a flowchart showing a flow of a marginless copy operation performed by the MFP 100 according to the exemplary embodiment. The marginless copy operation shown in FIG. 9 is executed by a CPU 101 at STEP S420 shown in FIG. 4.

At STEP S901, the CPU 101 determines whether a currently set copy mode is a marginless copy mode. If the marginless copy mode is selected, the CPU 101 performs processing of STEPs S902 to S904 and of STEP S905.

At STEP S902, the CPU 101 sets top, bottom, left, and right marginless widths for a recording sheet size set by an operator at STEP S402 shown in FIG. 4. As in the case of the first exemplary embodiment, the top, bottom, left, and right marginless widths of approximately 4.5 mm, 8 mm, 3 mm, and 6 mm, respectively, are set for an L-size recording sheet.

At STEP S903, the CPU 101 sets a non-marginless enlarged area and determines a non-marginless enlargement factor. More specifically, the CPU 101 divides the document into two kinds of areas, namely, a marginless enlarged area and a non-marginless enlarged area. An enlargement factor is decided based on a marginless width in the marginless enlarged area, whereas an enlargement factor is decided based on obtained document size and recording sheet size instead of the marginless widths in the non-marginless enlarged area. The CPU 101 then determines a non-marginless enlargement factor for the non-marginless enlarged area. The non-marginless enlargement factor can be calculated by the following equations based on the obtained document size and recording sheet size.

Vertical Non-marginless Enlargement Factor=(Vertical Width of Recording Sheet)/(Vertical Width of Document)

Horizontal Non-marginless Enlargement Factor=(Horizontal Width of Recording Sheet)/(Horizontal Width of Document)

At STEP S904, the CPU 101 determines top, bottom, left, and right marginless enlargement factors based on the marginless widths and widths of the marginless enlarged area. Meanwhile, the marginless enlargement factors can be calculated by the following equations based on the obtained document size and recording sheet size, the marginless widths, the marginless enlarged area widths of the recording sheet.

Top Marginless Enlargement Factor=(Top Marginless Enlarged Area Width of Recording Sheet+Top Marginless Width)/(Top Marginless Enlarged Area Width of Document)

Bottom Marginless Enlargement Factor=(Bottom Marginless Enlarged Area Width of Recording Sheet+Bottom Marginless Width)/(Bottom Marginless Enlarged Area Width of Document)

Left Marginless Enlargement Factor=(Left marginless Enlarged Area Width of Recording Sheet+Left Marginless Width)/(Left Marginless Enlarged Area Width of Document)

Right Marginless Enlargement Factor=(Right marginless Enlarged Area Width of Recording Sheet+Right Marginless Width)/(Right Marginless Enlarged Area Width of Document)

Although calculation of six kinds of enlargement factors is described in this exemplary embodiment, the enlargement factors are actually applied to enlarged areas resulting from division of an enlarged area into nine areas, namely, upper left, upper, upper right, left, central, right, lower left, lower, and lower right areas with respect to the center of the original image formed on the recording sheet.

For example, in an upper left area with respect to the center of the original image formed on a recording sheet, the top marginless enlargement factor and left marginless enlargement factor are applied in the vertical and horizontal directions, respectively. In an upper area with respect to the center of the original image formed on a recording sheet, the top marginless enlargement factor and the horizontal non-marginless enlargement factor are applied in the vertical and horizontal directions, respectively.

At STEP S904, the CPU 101 determines marginless enlargement factors. At STEP S905, the CPU 101 enlarges (scales) the document based on the marginless enlargement factors determined at STEP S904 to perform a copy operation.

### 1.2. Result of Marginless Copy Operation

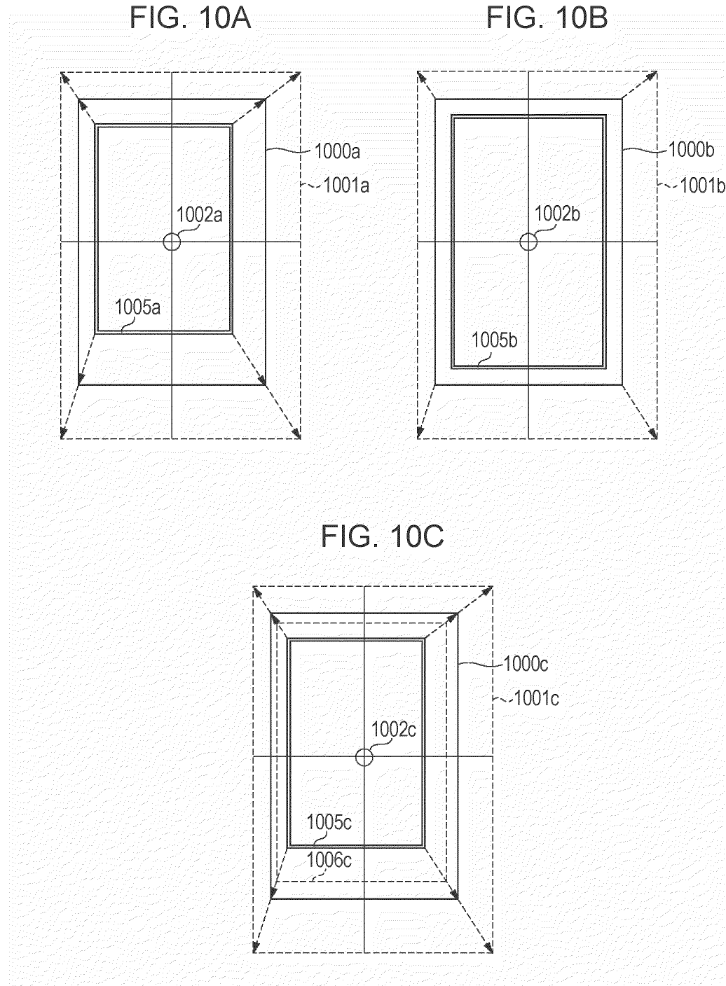

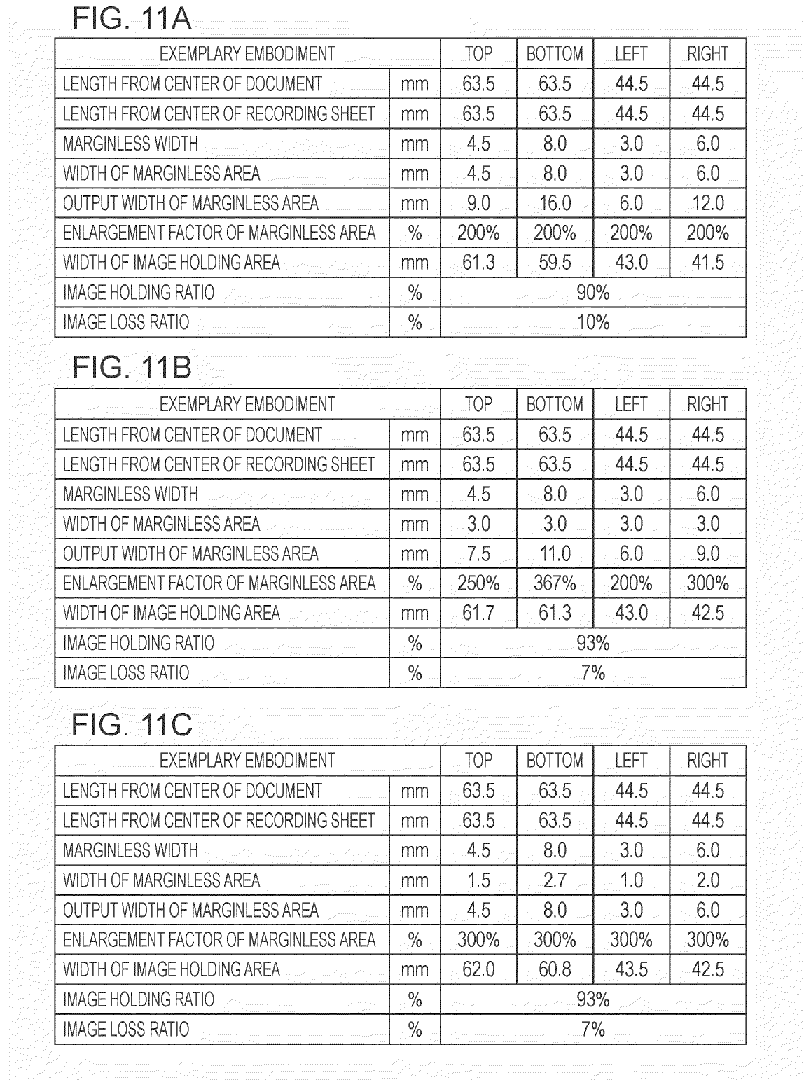

Layout of an original document and a recording sheet employed at the time of a marginless copy operation executed by the MFP 100 according to the exemplary embodiment and an image loss ratio of this case will now be described with reference to FIGS. 10A and 11A.

FIG. 10A shows layout of a document and a recording sheet when a marginless enlarged area having a width equal to a marginless width is set.

FIG. 11A shows an image loss ratio resulting from calculation performed on the layout shown in FIG. 10A.

Referring to FIG. 10A showing an example layout employed in the MFP 100 according to the exemplary embodiment, a thick solid line 1000a shows a size of a document, whereas a thick broken line 1001a shows a size of a recording area. In addition, a circle 1002a shows a center of an original image and a center of the original image formed on the recording sheet. Additionally, a double line 1005a indicates a boundary between the marginless enlarged area and the non-marginless enlarged area. Inside of the double line 1005a corresponds to the non-marginless enlarged area, whereas outside of the double line 1005a corresponds to the marginless enlarged area. Vertical and Horizontal lengths of the double line 1005a are shorter than vertical and horizontal lengths of the line 1000a, respectively, by top, bottom, left, and right marginless widths.

FIG. 11A shows an image loss ratio obtained when the MFP 100 according to the exemplary embodiment is used for such a layout. Meanwhile, the image loss ratio is calculated for an L-size document and vertical and horizontal document sizes are 127 mm and 89 mm, respectively. A length from the center of the original image to the top or bottom edge is 63.5 mm, whereas a length from the center of the original image to the left or right edge is 44.5 mm. In addition, since the size of the recording sheet is also the L-size, lengths from a center of an original image formed on a recording sheet is the same as the above-described lengths from the center of the original image.

In the exemplary embodiment, a marginless enlarged area having widths equal to the marginless widths from edges of an original image is set. The image included in this area is enlarged according to the marginless width and the information recorded outside of the recording sheet is lost. As described above, the top, bottom, left, and right marginless widths are equal to 4.5 mm, 8 mm, 3 mm, and 6 mm, respectively, in FIG. 11A.

Recording area widths of the marginless enlarged area are equal to values obtained by adding the marginless widths to the marginless enlarged area width. Accordingly, top, bottom, left, and right recording area widths are equal to 9.0 mm, 16.0 mm, 6.0 mm, and 12.0 mm, respectively. Since an image included in the marginless enlarged area is enlarged so that the image covers the marginless recording area width in the marginless copy operation, the marginless area enlargement factor is equal to 200% (=top marginless recording area width 9.0 mm÷top marginless area width 4.5 mm).

More specifically, 50% (=1÷marginless area enlargement factor 200%) of the image included in the marginless enlarged area is recorded on a recording sheet and the rest of the image is recorded outside of the recording sheet and is lost. Accordingly, a length of an image holding area is equal to a value obtained by subtracting 50% of the marginless area width from a length of the recording sheet. In the example case, the length of the image holding area is equal to 61.3 (=length from the center of the original image to the top edge of the recording sheet 63.5−top marginless area width 4.5 mm/2).

An image holding ratio is determined by the following equation by using top, bottom, left, and right image holding area widths.

Image Holding Ratio=(Top Holding Area Width 61.3 mm+Bottom Holding Area Width 59.5 mm)×(Left Holding Area Width 43.0 mm+Right Holding Area Width 41.5 mm)/(Size of Document: 127 mm×89 mm).

As a result, referring to FIG. 11A, the image holding ratio is equal to 90% and an image loss ratio is equal to 100%−90%=10%.

More specifically, 10% of information of an original image is recorded outside of a recording sheet and is lost.

As described above, the image loss ratio can be further reduced by setting a non-marginless enlarged area to limit distortion of an image locally.

In addition, when the non-marginless enlarged area is determined based on the marginless widths, the enlargement factors of the marginless enlarged area are constant. Accordingly, image distortion caused by anisotropy of enlargement factors advantageously becomes less conspicuous.

### Third Exemplary Embodiment

In the above-described second exemplary embodiment, the description has been given for a marginless copy operation when a marginless enlarged area having widths equal to marginless widths is set. However, the present invention is not limited to such a setting.

A description will be given below for an image loss ratio obtained when a smallest width of top, bottom, left, and right marginless widths is set as the width of a marginless enlarged area with reference to FIGS. 10B and 11B.

FIG. 10B shows layout of a document and a recording area when the smallest width of top, bottom, right, and left marginless widths is set as the width of an marginless enlarged area. FIG. 11B shows an image loss ratio resulting from calculation performed on the layout shown in FIG. 10B.

Referring to FIG. 10B showing an example layout employed in the MFP 100 according to the exemplary embodiment, a thick solid line 1000b shows a size of a document, whereas a thick broken line 1001b shows a size of a recording area. In addition, a circle 1002b shows a center of an original image and a center of the original image formed on the recording sheet. Additionally, a double line 1005b indicates a boundary between a marginless enlarged area and a non-marginless enlarged area. Inside of the double line 1005b corresponds to the non-marginless enlarged area, whereas outside of the double line 1005b corresponds to the marginless enlarged area. Vertical and horizontal lengths of the double line 1005b are shorter than vertical and horizontal lengths of the line 1000b, respectively, by an identical value in the top, bottom, left, and right directions.

FIG. 11B shows an image loss ratio obtained when the MFP 100 according to the exemplary embodiment is used for such a layout. Meanwhile, the image loss ratio is calculated for an L-size document and vertical and horizontal document sizes are 127 mm and 89 mm, respectively. A length from the center of the original image to the top or bottom edge is 63.5 mm, whereas a length from the center of the original image to the left or right edge is 44.5 mm. In addition, since the size of the recording sheet is also the L-size, lengths from a center of an original image formed on a recording sheet is the same as the above-described lengths from the center of the original image.

In this exemplary embodiment, marginless enlarged areas having a width equal to the smallest width of top, bottom, left, and right marginless widths from edges of the original image are set at the top, bottom, left, and right. An image included in this area is enlarged according to the marginless widths. Information recorded outside of a recording sheet is lost.

As described above, the top, bottom, left, and right marginless widths are equal to 4.5 mm, 8 mm, 3 mm, and 6 mm, respectively, in FIG. 11B. Recording area widths of the marginless area are equal to values obtained by adding the top, bottom, left, and right marginless widths to the marginless enlarged area width (=the smallest width 3.0 mm of the top, bottom, left, and right marginless widths). Accordingly, the top, bottom, left, and right recording area widths are equal to 7.5 mm, 11.0 mm, 6.0 mm, and 9.0 mm, respectively. Since an image included in the marginless enlarged area is enlarged so that the image covers the marginless recording area width in the marginless copy operation, top, bottom, left, and right marginless area enlargement factors are equal to 250% (=top marginless recording area width 7.5 mm÷marginless area width 3.0 mm), 367%, 200%, and 300%, respectively.

More specifically, the ratios of an image to be recorded on the recording sheet is determined according to the top, bottom, left, and right marginless enlarged area widths. For example, a top image holding ratio is equal to 40% (=1÷top marginless area enlargement factor 250%) and the rest of the image is recorded outside of the recording sheet and is lost. Accordingly, an image loss ratio is equal to a value obtained by subtracting the top image holding ratio from 100%. For example, the top image loss ratio is equal to 60%=100%−40%. A length of an image holding area is equal to a value obtained by subtracting the marginless enlarged area width×the image loss ratio from a length of the recording sheet. Accordingly, the length of the image holding area is approximately 61.7 mm=a length from the center of the original image to the top edge of the recording sheet 63.5−top marginless enlarged area width 3 mm×top image loss ratio 60%. An image holding ratio is determined by the following equation using the top, bottom, left, and right image holding area widths.

Image Holding Ratio=(Top Holding Area Width 61.7 mm+Bottom Holding Area Width 61.3 mm)×(Left Holding Area Width 43.0 mm+Right Holding Area Width 42.5 mm)/(Size of Document: 127 mm×89 mm).

As a result, referring to FIG. 11B, the image holding ratio is equal to 93% and an image loss ratio is equal to 100%−93%=7%. More specifically, 7% of information of an original image is recorded outside of a recording sheet and is lost.

As described above, distortion of an image can be limited locally and the image loss ratio can be further reduced by setting a width of a marginless enlarged area to a smallest value of top, bottom, left, and right marginless widths.

In addition, when a marginless enlarged area width commonly used at the top, bottom, left, and right is determined based on the smallest value of the top, bottom, left, and right marginless widths, the marginless enlarged area width is constant at the top, bottom, left, and right. Accordingly, image distortion caused by anisotropy of the marginless enlarged area widths advantageously becomes less conspicuous.

### Fourth Exemplary Embodiment

In the second and third exemplary embodiments, enlargement factors of a marginless enlarged area in respective directions are set constant. However, when a difference between enlargement factors of a non-marginless enlarged area and a marginless enlarged area or a ratio thereof is large, a change in the enlargement factors at a boundary between the non-marginless enlarged area and the marginless enlarged area increases. As a result, image distortion becomes conspicuous at the boundary area.

Accordingly, in this exemplary embodiment, two-step marginless enlarged areas are set and enlargement factors are set to satisfy a relation of an enlargement factor of a non-marginless enlarged area<an enlargement factor of a second marginless enlarged area<an enlargement factor of a first enlarged area. In this manner, the enlargement factors changes in two steps. By setting the enlargement factors in this manner, a change in the enlargement factors can be suppressed and image distortion can be made less conspicuous. A detail of this exemplary embodiment will be described below.

FIG. 10C shows layout of a document and a recording area when two-step marginless enlarged areas are provided and widths of first and second marginless enlarged areas are set to ⅓ and ⅔ of marginless widths. FIG. 11C shows an image loss ratio resulting from calculation performed on the layout shown in FIG. 10C.

Referring to FIG. 10C showing an example layout employed in the MFP 100 according to the exemplary embodiment, a thick solid line 1000c shows a size of a document, whereas a thick broken line 1001c shows a size of a recording area. In addition, a circle 1002c shows a center of an original image and a center of the original image formed on the recording sheet. Additionally, a double line 1005c indicates a boundary between the second marginless enlarged area and the non-marginless enlarged area. A thick doted line 1006c indicates a boundary between the first marginless enlarged area and the second marginless enlarged area. Inside of the double line 1005b corresponds to the non-marginless enlarged area, whereas an area between the lines 1005b and 1006c corresponds to the second marginless enlarged area. Outside of the dotted line 1006c corresponds the first marginless enlarged area. The double line 1005c is the same as the line 1005a shown in FIG. 10A. The line 1006c is placed at a position that divides a distance between the lines 1000c and 1005c internally in the ratio 1:2.

The MFP 100 according to the exemplary embodiment employs a marginless copy method for enlarging an image of the second marginless enlarged area between the lines 1005c and 1006c to an area between 1005c and 1000c and recording the enlarged image on a recording sheet. In addition, the first marginless enlarged area between the lines 1006c and 1000c is enlarged to an area between the lines 1000c and 1001c and is recorded outside of the recording sheet and is lost. Accordingly, the enlargement factor and the image loss ratio relatively increase in the outer image.

FIG. 11C shows an image loss ratio obtained when the MFP 100 according to the exemplary embodiment is used for such a layout. Meanwhile, the image loss ratio is calculated for an L-size document and vertical and horizontal document sizes are 127 mm and 89 mm, respectively. A length from the center of the original image to the top or bottom edge is 63.5 mm, whereas a length from the center of the original image to the left or right edge is 44.5 mm. In addition, since the size of the recording sheet is also the L-size, lengths from a center of an original image formed on a recording sheet is the same as the above-described lengths from the center of the original image.

In FIG. 11C, top, bottom, left, and right marginless widths are equal to 4.5 mm, 8 mm, 3 mm, and 6 mm, respectively. The marginless area widths shown in FIG. 11C correspond to first marginless area widths, which are ⅓ of the marginless widths. Accordingly, the top, bottom, left, and right first marginless area widths are equal to 1.5 mm, 2.7 mm, 1.0 mm, and 2.0 mm, respectively. Additionally, recording area widths of the marginless area shown in FIG. 11C correspond to recording area widths of the first marginless area. Accordingly, the recording area widths are equal to the marginless widths. Since an image included in the marginless enlarged area is enlarged so that the image covers the recording area width of the marginless area, a marginless area enlargement factor is equal to 300% (=recording area width 4.5 mm of the top marginless area÷top marginless area width 1.5 mm).

As a result, since the first marginless enlarged area is recorded outside of a recording sheet and is lost, a length of an image holding area is equal to a value obtained by subtracting the marginless area width from the length of a recording sheet. For example, a length of a top image holding area is approximately equal to 62.0 mm=a length from the center of the original image to the top edge of the recording sheet 63.5−top marginless area width 1.5 mm.

An image holding ratio is determined by the following equation based on the top, bottom, left, and right image holding area widths determined in this manner.

Image Holding Ratio=(Top Holding Area Width 62.0 mm+Bottom Holding Area Width 60.8 mm)×(Left Holding Area Width 43.5 mm+Right Holding Area Width 42.5 mm)/(Size of Document: 127 mm×89 mm).

As a result, referring to FIG. 11C, the image holding ratio is equal to 93% and an image loss ratio is equal to 100%−93%=7%. More specifically, 7% of information of an original image is recorded outside of a recording sheet and is lost.

In addition, since the second marginless enlarged area is the area between the lines 1005c and 1006c and corresponds to an area between the lines 1005c and 1000c on a recorded sheet after the enlargement, the enlargement factor of the second marginless enlarged area is equal to 150%. Accordingly, the enlargement factors of the non-marginless enlarged area, the second marginless enlarged area, and the first marginless enlarged area are equal to 100%, 150%, and 200%, respectively. Rates of change in the enlargement factors at the boundary 1005c between the non-marginless enlarged area and the second marginless enlarged area and at the boundary 1006c between the second marginless enlarged area and the first marginless enlarged area are equal to 150% (=150%/100%) and 200% (=300%/150%).

On the other hand, as shown in FIG. 11A, when only one kind of marginless enlarged area is set, the rate of change in the enlargement factors at the boundary 1005a between the non-marginless enlarged area and the marginless enlarged area is equal to 250% (=250%/100%).

As described above, an image loss ratio can be further reduced while decreasing the rate of change in the enlargement factors of an image, namely, the rate of change in image distortion, by providing two-step marginless enlarged area and setting the enlargement ratios step by step.

Although the two-step marginless enlarged areas are set in this exemplary embodiment, the steps are not limited to two. The kinds of the marginless enlarged areas may be increased and the enlargement factors may be increased toward each edge based on the marginless widths according to a distance from the center of an original image (as the position approaches the edges of the original image). This can further reduce the image loss ratio while decreasing the rate of change in the enlargement factors.

### Fifth Exemplary Embodiment

In the above-described second exemplary embodiment, the description has been given for a case where an image loss ratio is further reduced while avoiding occurrence of image distortion by providing a non-marginless enlarged area in an original image. However, the present invention is not limited to this configuration.

In this exemplary embodiment, a description will be given for a case where an original image is analyzed as a non-marginless enlarged area and an area not suitable as an enlarged area is set as a non-enlarged area.

In general, required image accuracy differs between an area including a main subject and the rest of the area in a copy operation of image data, such as a photograph image. When top, bottom, left, and right enlargement factors are set based on respective marginless widths as described in the first exemplary embodiment, the enlargement factors of the image and the rate of change in the enlargement factors are suppressed. However, since the enlargement factors in respective directions from the center of the original image differ, the entire image is distorted.

In addition, when a non-marginless enlarged area is set at a central portion of an image as described in the second exemplary embodiment, the position and size of the non-marginless enlarged area are maintained. However, the enlargement factors of the image increase.

On the other hand, such distortion is remarkably recognized in a main subject, e.g., an object such as a human face, but is not remarkably recognized in an object such as sky, beach, and thick trees.

Accordingly, in this exemplary embodiment, the image distortion is made inconspicuous by setting a main subject containing area, such as a human face area, where the image distortion is remarkably recognized, as a non-marginless enlarged area.

A description will given for an example for making image distortion inconspicuous by setting a main subject containing area as a non-marginless enlarged area in this exemplary embodiment.

### 1. Detail of Copy Operation

### 1.1 Flow of Marginless Copy Operation

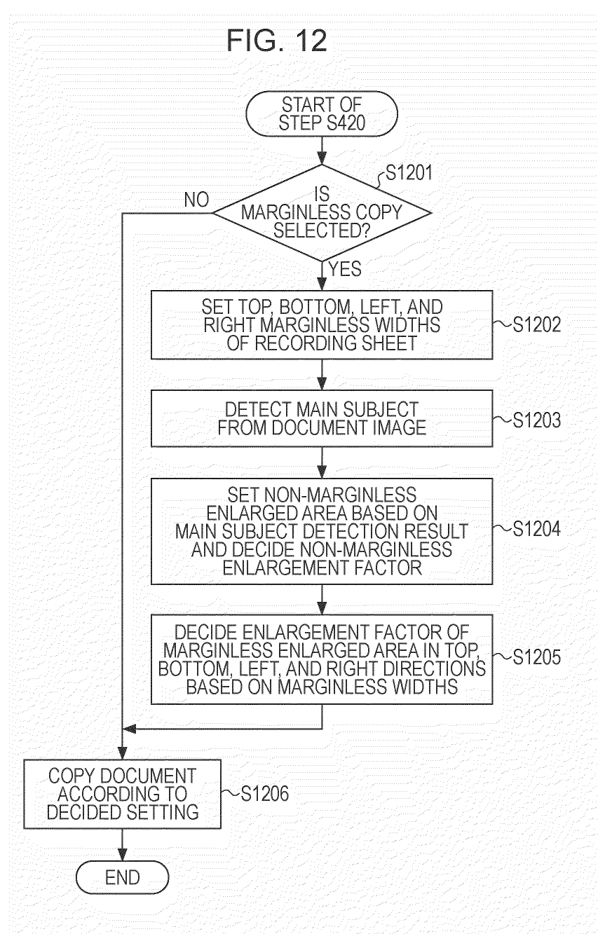

FIG. 12 is a flowchart showing a flow of a marginless copy operation executed by an MFP 100 according to this exemplary embodiment. The marginless copy operation shown in FIG. 12 is executed by a CPU 101 at STEP S420 shown in FIG. 4.

At STEP S1201, the CPU 101 determines whether a currently set copy mode is a marginless copy mode. If the marginless copy mode is selected, the CPU 101 performs processing of STEPs S1202 to S1205 and of STEP S1206.

At STEP S1202, the CPU 101 sets top, bottom, left, and right marginless widths for a recording sheet size set by an operator at STEP S402 shown in FIG. 4. As in the case of the first exemplary embodiment, top, bottom, left, and right marginless widths of approximately 4.5 mm, 8 mm, 3 mm, and 6 mm are set for a L-size recording sheet in this exemplary embodiment.

At STEP S1203, the CPU 101 detects a main subject from an original image. A method for detecting the main subject is not limited to a specific method and any methods can be used. For example, when the main subject is a human face, a method for extracting skin-color data and recognizing a cluster at a photometric point determined as a skin-color area as a face is known as a method for extracting a human face from an original image.

More specifically, Japanese Patent Laid-Open Nos. 52-156624, 53-14521, and 53-145622 disclose the methods. Furthermore, Japanese Patent Laid-Open No. 4-346333 discloses a method for determining a face area by converting photometric data into hue and chroma data, creating a two-dimensional histogram, and analyzing the histogram. In addition, Japanese Patent Laid-Open No. 8-063597 discloses a method for extracting a face candidate area corresponding to a shape of a human face and deciding a face area based on a feature value of the area.

At STEP S1203, the CPU 101 detects a size and a position of a main subject. The process then proceeds to STEP S1204.

At STEP S1204, the CPU 101 sets a non-marginless enlarged area based on the size and position of the main subject detected at STEP S1203 and determines a non-marginless enlargement factors. The enlargement factors are determined by the following equations as in the case of the second exemplary embodiment.

Vertical Non-marginless Enlargement Factor=(Vertical Width of Recording Sheet)/(Vertical Width of Document)

Horizontal Non-marginless Enlargement Factor=(Horizontal Width of Recording Sheet)/(Horizontal Width of Document)

At STEP S1205, the CPU 101 determines top, bottom, left, and right marginless enlargement factors based on the marginless widths and widths of a marginless enlarged area of a recording sheet. The enlargement factors can be determined by the following equations as in the case of the second embodiment.

Top Marginless Enlargement Factor=(Width between Upper Edge of Main Subject Containing Area of Recording Sheet and Upper Edge of Recording Sheet+Top Marginless Width)/(Width between Upper Edge of Main Subject Containing Area of Document and Upper Edge of Document)

Bottom Marginless Enlargement Factor=(Width between Lower Edge of Main Subject Containing Area of Recording Sheet and Lower Edge of Recording Sheet+Bottom Marginless Width)/(Width between Lower Edge of Main Subject Containing Area of Document and Lower Edge of Document)

Left Marginless Enlargement Factor=(Width between Left Edge of Main Subject Containing Area of Recording Sheet and Left Edge of Recording Sheet+Left Marginless Width)/(Width between Left Edge of Main Subject Containing Area of Document and Left Edge of Document)

Right Marginless Enlargement Factor=(Width between Right Edge of Main Subject Containing Area of Recording Sheet and Right Edge of Recording Sheet+Right Marginless Width)/(Width between Right Edge of Main Subject Containing Area of Document and Right Edge of Document)

Although calculation of six kinds of enlargement factors is described in this exemplary embodiment, the enlargement factors are actually applied to enlarged areas resulting from division of an enlarged area into nine areas, namely, upper left, upper, upper right, left, central, right, lower left, lower, and lower right areas with respect to the center of the original image formed on the recording sheet. For example, in an upper left region with respect to the center of the original image formed on a recording sheet, the top marginless enlargement factor and left marginless enlargement factor are applied in the vertical and horizontal directions, respectively. In an upper area with respect to the center of the original image formed on a recording sheet, the top marginless enlargement factor and the horizontal non-marginless enlargement factor are applied in the vertical and horizontal directions, respectively.

At STEP S1205, the CPU 101 determines marginless enlargement factors. At STEP S1206, the CPU 101 enlarges (scales) the document based on the determined marginless enlargement factor to perform a copy operation.

### 1.2. Result of Marginless Copy Operation

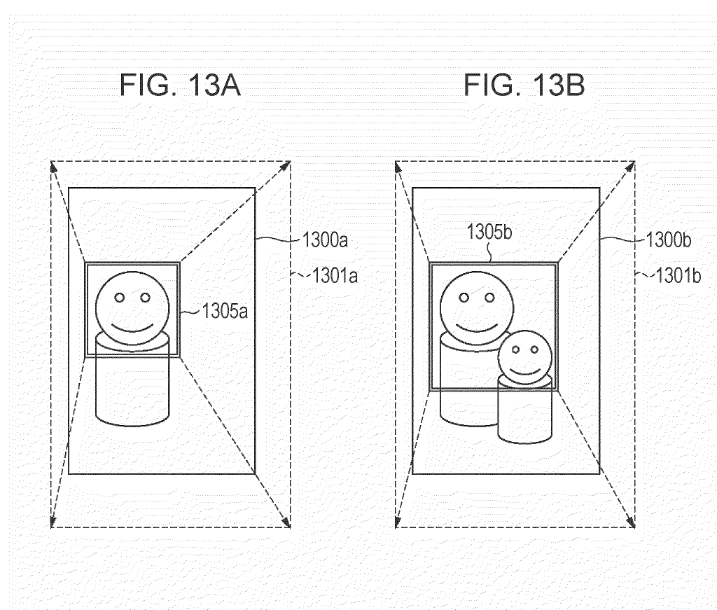

Layout of an original document and a recording sheet at the time of a marginless copy operation executed by the MFP 100 according to the exemplary embodiment and an image loss ratio of this case will now be described with reference to FIG. 13A.

FIG. 13A shows that a detected human face area is set as a non-marginless enlarged area.

Referring to FIG. 13A showing an example layout employed in the MFP 100 according to the exemplary embodiment, a thick solid line 1300a shows a size of a document, whereas a thick broken line 1301a shows a size of a recording area. A double line 1305a shows a detected human face area. Vertical and horizontal lengths of the double line 1305a indicate a size of the detected face area. An area enclosed by the double line 1305a is a non-marginless enlarged area, whereas an area between the lines 1305a and 1300a is a marginless enlarged area.

Since the human face is located on the left of the center of the document in FIG. 13A, marginless enlargement factors are set so that a relation of a left marginless enlargement factor>a right marginless enlargement factor is satisfied. By setting the enlargement factors in this manner, only the main subject containing area is set as the non-marginless enlarged area. The size and position of the main subject is preserved and an increase in the enlargement factors in the rest of the area is limited to a necessary amount. In addition, since the position of the main subject differs for each original document, a suitable non-marginless enlarged area can be set for each original image.

Meanwhile, when the main subject is not detected at STEP S1203 shown in FIG. 12, an marginless enlargement operation may be performed with respect to the center of the original image as in the case of the first exemplary embodiment (this is equivalent to a case where a subject located at the center of the document and having the size of 0 is detected and set). Alternatively, as in the case of the second exemplary embodiment, a predetermined non-marginless enlarged area may be provided at a central portion of an original image (this is equivalent to a case where a subject located at the center of the document and having the size of a predetermined value is detected and set).

### Sixth Exemplary Embodiment

In the fifth exemplary embodiment, the description has been given for a case of detecting one face. In this exemplary embodiment, a case of detecting a plurality of human faces will be described.

FIG. 13B shows that an area including detected two human faces is set as a non-marginless enlarged area.

Referring to FIG. 13B showing an example layout employed in the MFP 100 according to the exemplary embodiment, a thick solid line 1300b shows a size of a document, whereas a thick broken line 1301b shows a size of a recording area. Additionally, a double line 1305b shows an area including a plurality of detected human faces. Vertical and horizontal lengths of the double line 1305b indicate a size of the detected area including the plurality of human faces. An area enclosed by the double line 1305b is a non-marginless enlarged area, whereas an area between the lines 1305b and 1300b is a marginless enlarged area.

In this exemplary embodiment, a main subject containing area is set as follows:

an upper edge of the main subject containing area=the highest position of the upper edges of a plurality of detected areas including faces;

a lower edge of the main subject containing area=the lowest position of the lower edges of a plurality of detected areas including faces;

a left edge of the main subject containing area=the leftmost position of the left edges of a plurality of detected areas including faces; and

a right edge of the main subject containing area=the rightmost position of the right edges of a plurality of detected areas including faces.

By setting the main subject containing area in this manner, an area including all of human faces can be set as a non-marginless enlarged area and the rest can be set as a marginless enlarged area in the case of a group photograph. Meanwhile, since the following processing is the same as that of the fifth exemplary embodiment, a description thereof is omitted.

As is clear from the description given above, according to the exemplary embodiment, since only the main subject containing area is set as a non-marginless enlarged area, the size and position of the main subject containing area is preserved and an increase in the enlargement factors of the rest of the area is limited to a necessary amount. In addition, since the position of the main subject differs for each original document, a suitable non-marginless enlarged area can be set for each original image.

Although the description has been given for an example of employing human faces as a main subject in this exemplary embodiment, the main subject is not limited to the human faces. The main subject may be a subject, such as characters and figures constituted by straight lines, whose distortion due to a change in enlargement factors and anisotropy is remarkably recognized. Such a subject may be detected and set as a non-marginless enlarged area in the similar manner.

In addition, when a size of a main subject is remarkably large relative to a document and enlargement factors of a marginless enlarged area become significantly large, it is significantly difficult to maintain the position and size of the main subject without allowing viewers to recognize image distortion. In that case, it is preferable to stop maintaining the size and position and to avoid occurrence of image distortion by configuring a recorded image and marginless widths to be covered with the entire document as in the case of the related art.

Such a circumstance may be caused not only by the size of the main subject but also by a setting of a marginless width and a difference in a ratio or aspect ratio of the document size and the recording sheet size.

Meanwhile, the first to sixth exemplary embodiments are not necessarily carried out individually. The distortion resulting from enlargement may be made inconspicuous by combining the processing of a plurality of exemplary embodiments.

For example, a plurality of marginless enlarged area settings described in the third exemplary embodiment may be performed in an enlargement operation of a marginless enlarged area determined based on detection of a main subject according to the fifth exemplary embodiment, whereby a rate of change in enlargement factors can be advantageously reduced.

Meanwhile, the above-described marginless widths and enlargement factors based on the marginless widths are illustrative only. Since the marginless widths and the enlargement factors differ depending on a mechanical structure and a characteristic of an apparatus, it is obvious that the marginless widths and the enlargement factors are not limited to these values.

In addition, regarding the marginless widths, users may set a larger marginless width and a smaller marginless width in an identical apparatus. In that case, the enlargement factors of the marginless enlarged area are calculated according to the user setting.

Additionally, the marginless widths may be determined according to a print setting, such as a recording sheet size. In such a case, the enlargement factors of the marginless enlarged area are calculated according to the print setting.

Furthermore, although the description has been given for an example of a marginless copy operation, the present invention is not limited to a marginless copy operation. The present invention can be applied to a marginless card direct printing operation and a marginless cameral direct printing operation.

More specifically, when a digital image document having a predetermined number of pixels is recorded on a recording sheet, an output image whose center on the recording sheet is set to match the center of the digital image document can be obtained while reducing the image loss ratio.

Unlike the copy document described above, a physical length of a digital image document may not be specified. In that case, it is preferable to perform processing using the number of pixels as the size of the digital image document. More specifically, for example, the number of pixels of a digital image document is converted into a physical length using an output resolution or the like, whereby the size of the digital image document can be handled in the same manner as that of the copy document. To convert the number of pixels into the physical length, an output resolution, an input resolution, or other resolutions may be employed.

A ratio of a recording sheet size (an effective recording size of a recording sheet) to a document size, namely, a set scaling factor, can be detected using suitable methods. For example, the document size can be detected by a pre-scan operation as in the case of other copy operations. In addition, a user may manually input a value using a suitable user interface. The recording sheet size may be detected by a suitable sensor provided at a recording sheet cassette or may be manually input through an explicit user operation.

If the document size and the recording sheet size are determined, a relative scaling factor, namely, the above-described set scaling factor, can be calculated from the ratio therebetween (or an user interface that allows a user to directly select this set scaling factor through a manual operation is also possible).

In addition, although the description has been given for a case where marginless printing is performed on all of four edges, namely, top, bottom, right, and left edges, in the exemplary embodiment, the present invention is not limited to this configuration. For example, the present invention can be applied to a case where the marginless printing is performed only in the horizontal direction and the non-marginless printing is performed in the vertical direction. In such a case, a marginless enlarged area is set only in the horizontal direction of the document and a non-marginless enlarged area is set in the vertical direction.

### Other Exemplary Embodiments

The present invention may be applied to a system constituted by a plurality of devices (e.g., a host computer, an interface device, a reader, and a printer) or an apparatus (e.g., a copier and a facsimile machine) constituted by a single device.

In addition, an object of the present invention is achieved by providing a recording medium storing a program code of software realizing functions of the above-described embodiments to a system or an apparatus. In this case, a computer (or a CPU or an MPU) of the system or the apparatus reads out and executes the program code stored on the recording medium, whereby the above-described functions are realized. In this case, the recording medium storing the program code constitutes the present invention.

Types of the recording medium used for supplying the program code include, for example, a floppy disk®, a hard disk, a magneto-optical disc, an optical disc such as a CD-ROM and a CD-R, a magnetic tape, a nonvolatile memory card, and a ROM.

In addition, the present invention is not limited to a case where a computer executes the read out program code to realize the functions of the above-described exemplary embodiments. For example, a case where an operating system (OS) operating in the computer executes part of or all of actual processing on the basis of instructions of the program code and the functions of the above-described exemplary embodiments are realized by the processing is also included in the present invention.

Furthermore, a case where the functions of the above-described exemplary embodiments are realized after a program code read out from a recording medium is written in a memory included in a function expansion board inserted into a computer or a function expansion unit connected to the computer is also included in the present invention. More specifically, a CPU or the like included in the function expansion board or the function expansion unit executes part of or all of actual processing on the basis of instructions of the program code after the program code is written in the memory, through which the functions are realized. Such a case is also included in the present invention.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Application No. 2007-242909 filed Sep. 19, 2007, which is hereby incorporated by reference herein in its entirety.

What is claimed is:

1. An image processing apparatus that processes an input image to generate an output image to be recorded on a recording medium, the apparatus comprising:
a first obtaining unit configured to obtain a size of the input image;
a second obtaining unit configured to obtain a size of the recording medium;
a setting unit configured to set, in each of two directions orthogonal to each other, an overrunning amount caused if the input image were recorded on the recording medium without providing a margin;
a calculating unit configured to calculate a scaling factor in each of the two directions using the size of the recording medium, the overrunning amount, and the size of the input image; and
a generating unit configured to perform a scaling operation on the input image in the two directions based on the respective scaling factors to generate an output image.

2. The apparatus according to claim 1, wherein the calculating unit calculates a constant scaling factor regarding each of the two directions.

3. The apparatus according to claim 1, wherein the calculating unit calculates the scaling factor regarding each of the two directions so that the scaling factor increases according to a distance from a center of the input image.

4. The apparatus according to claim 1, further comprising:
a determining unit configured to determine an area of the input image that is not to undergo the scaling operation, and
wherein the calculating unit calculates a scaling factor in each of the two directions using the size of the recording medium, the overrunning amount, and the size of areas of the input image excluding the area determined by the determining unit.

5. The apparatus according to claim 4, further comprising:
a detecting unit configured to detect an area including a specific object included in the input image, and
wherein the determining unit determines the area detected by the detecting unit as the area that is not to undergo the scaling operation.

6. The apparatus according to claim 5, wherein the detecting unit detects an area including a face of a subject included in the input image.

7. The apparatus according to claim 5, wherein the detecting unit detects an area including faces of a plurality of subjects included in the input image.

8. An image processing apparatus that processes an input image to generate an output image to be recorded on a recording medium, the apparatus comprising:
a first obtaining unit configured to obtain a size of the input image;
a second obtaining unit configured to obtain a size of the recording medium;
a setting unit configured to set, in each of two directions orthogonal to each other, an overrunning amount caused if the input image were recorded on the recording medium without providing a margin;
a dividing unit configured to divide the input image into a plurality of areas;
a calculating unit configured to calculate a scaling factor of each of the plurality of areas in each of the two directions using the size of the recording medium, the overrunning amount, and the size of the input image; and
a generating unit configured to perform a scaling operation on the each of the plurality of areas in the two directions based on the respective scaling factors to generate an output image.

9. An image processing method for an image processing apparatus that processes an input image to generate an output image to be recorded on a recording medium, the method comprising:
obtaining a size of the input image;
obtaining a size of the recording medium;
setting, in each of two directions orthogonal to each other, an overrunning amount caused if the input image were recorded on the recording medium without providing a margin;
calculating a scaling factor in each of the two directions using the size of the recording medium, the overrunning amount, and the size of the input image; and
performing a scaling operation on the input image in the two directions based on the respective scaling factors to generate an output image.

10. An image processing method for an image processing apparatus that processes an input image to generate an output image to be recorded on a recording medium, the method comprising:
obtaining a size of the input image;
obtaining a size of the recording medium;
setting, in each of two directions orthogonal to each other, an overrunning amount caused if the input image were recorded on the recording medium without providing a margin;
dividing the input image into a plurality of areas;
calculating a scaling factor of each of the plurality of areas in each of the two directions using the size of the recording medium, the overrunning amount, and the size of the input image; and
performing a scaling operation on the each of the plurality of areas in the two directions based on the respective scaling factors to generate an output image.

11. A computer-readable recording medium storing a control program for allowing a computer to execute an image processing method for an image processing apparatus that processes an input image to generate an output image to be recorded on a recording medium, the method comprising:
obtaining a size of the input image;
obtaining a size of the recording medium;
setting, in each of two directions orthogonal to each other, an overrunning amount caused if the input image were recorded on the recording medium without providing a margin;
calculating a scaling factor in each of the two directions using the size of the recording medium, the overrunning amount, and the size of the input image; and
performing a scaling operation on the input image in the two directions based on the respective scaling factors to generate an output image.

12. A computer-readable recording medium storing a control program for allowing a computer to execute an image processing method for an image processing apparatus that processes an input image to generate an output image to be recorded on a recording medium, the method comprising:
obtaining a size of the input image;
obtaining a size of the recording medium;
setting, in each of two directions orthogonal to each other, an overrunning amount caused if the input image were recorded on the recording medium without providing a margin;
dividing the input image into a plurality of areas;
calculating a scaling factor of each of the plurality of areas in each of the two directions using the size of the recording medium, the overrunning amount, and the size of the input image; and
performing a scaling operation on the each of the plurality of areas in the two directions based on the respective scaling factors to generate an output image.
